(19) United States
(12) Patent Application Publication
(10) Pub. No.: US 2019/0013676 A1
(43) Pub. Date: Jan. 10, 2019

(54) Apparatus of Controlling Uninterruptible Power Supply for Grid

(71) Applicant: Institute of Nuclear Energy Research, Atomic Energy Council, Executive Yuan, R.O.C., Taoyuan City (TW)

(72) Inventors: Meng-Chen HOU, New Taipei City (TW); Shyh-Wern SUN, Taoyuan (TW); Yung-Ruei CHANG, Taoyuan (TW); Yih-Der LEE, Tainan (TW)

(21) Appl. No.: 15/645,129

(22) Filed: Jul. 10, 2017

(51) Int. Cl. H02J 3/38; H02J 3/00; H02J 3/28; H02J 3/06; H02J 3/08; H02J 3/14; H02J 3/40; H02J 3/46

(52) U.S. Cl. CPC H02J 3/382; H02J 3/006; H02J 3/28; H02J 3/06; H02J 3/08; Y10T 307/576; H02J 3/40; H02J 3/46; H02J 2003/001; H02J 2003/388; H02J 3/14

(57) ABSTRACT

An apparatus is provided for controlling uninterruptible power supply (UPS) for grid. It comprises a power bus; an energy storage system connected to the power bus; a load connected to the power bus; a renewable energy connected to the power bus; an extra generator connected to the power bus; a static switch connected to mains and the energy storage system; and a synchronizing switch connected to the extra generator. When the grid is turned from mains-connected to islanding or is already operated in an islanding mode owing to the failure of the energy storage system, the extra generator can be used as a voltage source. The stability and safety of the grid is enhanced. Furthermore, the voltage source can be put under the control of either the energy storage system or the extra generator according to requirements. Thus, stability and reliability of power supply for the grid are increased.

### TECHNICAL FIELD OF THE INVENTION

The present invention relates to uninterruptible power supply (UPS) for grid; more particularly, to avoiding black-out of the grid owing to the failure of an energy storage system, where, according to requirements, mastership can be exchanged between an energy storage system and an extra generator for enhancing stability and reliability of power supply.

### DESCRIPTION OF THE RELATED ARTS

In recent years, a grid may contain a variety of distributed power generation devices (such as solar generator, wind turbine generator and biomass generator) with a number of loads. Besides, energy storage system and fast switches (such as static switches) connecting the grid with electricity network are also essential devices. Therein, the energy storage system can improve power quality of the grid and regulate the power generation of renewable energy resources and the power consumption of loads for achieving a balance between supply and demand. Thus, the energy storage system has become an important, indispensable device.

In practice, the energy storage system itself is not a stable device. It may become dysfunctional or even out of order due to the damage of battery pack, the connection failure of inverter, or the communication interference. Among them, the damage of the battery pack occurs most frequently. The storage of energy inside a battery depends on chemical reactions. However, changes in weather and environment often cause unexpected impact to the battery pack, such as damage in battery cells. In addition, the lifespans of battery cells have limitation and may be shortened due to voltage unbalance away cells, which would result in slight differences in their chemical reactions. In a long term, their lifespans will not be congruent. Extremely low voltage may thus appear on some battery packs, which need to be charged separately from time to time or even replaced ultimately. This may affect the long-term continuous operation of the grid.

A prior art discloses an energy storage system in microgrid for mode transfer. The energy storage system is interlinked with a static switch. When the energy storage system switches its control mode, the static switch is operated accordingly. Thus, it can switch from mains-connected to islanding very fast. However, it has the following two disadvantages:

1. When it is mains-connected but the energy storage system fails, the mains suddenly disappears and the grid turns to be operated under the islanding mode. But, at the moment, there is no internal voltage source to control voltage and frequency of the grid. As a result, the grid blacks out.

2. If the energy storage system suddenly fails under the islanding mode, there is no alternative voltage source and the grid will black out.

Another prior art reveals a grid system having two energy storage systems. The two energy storage systems have several operation modes. According to the voltages, currents and abnormal signals in the two energy storage systems, performance and reliability of the energy storage systems are enhanced for prolonging their use lives. However, it also has the following two disadvantages:

1. The two energy storage systems greatly raise cost. Besides, as the number of energy storage systems increases, there will be more problems concerning stability and security.

2. In such a configuration, when mains is operated abnormally and renewable energy is insufficient, the two energy storage systems cannot continue to provide fulfilling power even though their power storage capacities are large enough.

Hence, the prior arts do not fulfill all users' requests on actual use.

### SUMMARY OF THE INVENTION

The main purpose of the present invention is to avoid black-out of a grid owing to failure of an energy storage system, where, according to requirements, mastership can be exchanged between an energy storage system and an extra generator for enhancing stability and reliability of power supply.

Another purpose of the present invention is to use the extra generator as a voltage source for enhancing stability and security of the grid when the grid turns from mains-connected to be operated under an islanding mode or when the grid is operated under the islanding mode owing to failure of the energy storage system.

To reach the above purposes, the present invention is an apparatus of controlling UPS for grid, comprising a power bus, an energy storage system, a load, a renewable energy, at least one extra generator, a static switch, and at least one synchronizing switch, where the energy storage system is connected to the power bus; the load is connected to the power bus; the renewable energy is connected to the power bus; the extra generator is connected to the power bus; the static switch is connected to mains and the energy storage system; the synchronizing switch is connected to the extra generator; and a grid has a voltage source selected from the energy storage system and a complex power generating device. Accordingly, a novel apparatus of controlling UPS for grid is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the first state-of-use of the preferred embodiment according to the present invention; and

FIG. 2 is the view showing the second state-of-use.

### DESCRIPTION OF THE PREFERRED EMBODIMENT

The following description of the preferred embodiment is provided to understand the features and the structures of the present invention.

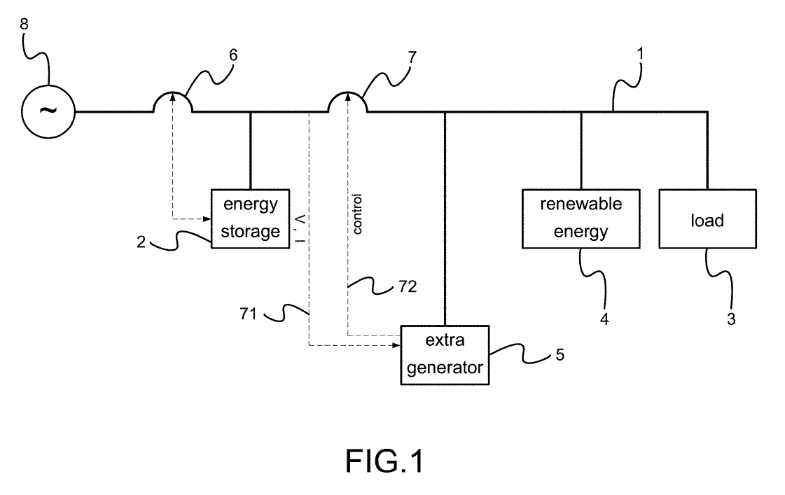

Please refer to FIG. 1, which is a view showing a first state-of-use of the preferred embodiment according to the present invention. As shown in the figure, the present invention is an apparatus of controlling uninterruptible power supply (UPS) for grid, where a grid has a voltage source selected from an energy storage system and a complex power generating device. The present invention comprises a power bus 1, an energy storage system 2, a load 3, a renewable energy 4, an extra generator 5, a static switch 6, and a synchronizing switch 7.

The energy storage system 2 is connected to the power bus 1.

The load 3 is connected to the power bus 1.

The renewable energy 4 is connected to the power bus 1.

The extra generator 5 is connected to the power bus 1.

The static switch 6 is connected to mains 8 and the energy storage system 2.

The synchronizing switch 7 comprises a primary 71 and a secondary 72, and is connected to the extra generator 5. Thus, a novel apparatus of controlling UPS for grid is obtained.

In a modern grid, an energy storage system is used as a voltage source to control voltage and frequency of the grid under an islanding mode, where the power difference between the generated power and the load is balanced. When the energy storage system fails or is operated abnormally, the grid may black out. Under this consideration, the present invention adds an extra generator and a power bus controlled by the extra generator, so that the voltage source can be replaced when the energy storage system fails. Therein, the extra generator can be multiple.

On using the present invention, there are three scenarios, where the first state-of-use comprises the first two scenarios.

Scenario 1: Energy storage system operated normally and extra generator closed

When the energy storage system 2 is operated normally and mains 8 is operated abnormally, the grid turns from mains-connected to islanding. Then, the energy storage system 2 is functioned as a voltage source under the islanding mode; and the extra generator 5 is turned on to be functioned as a power provider in a P/Q mode (for avoiding long standby of the extra generator 5). If the energy storage system 2 fails when the grid is operated under an islanding mode, the extra generator 5 will replace the energy storage system 2 and become the voltage source.

When the failed energy storage system 2 is back to be operated normally under the islanding mode, the extra generator 5 will detect a voltage at the primary 71 of the synchronizing switch 7. After synchronizing the voltage, the synchronizing switch 7 is closed and the energy storage system 2 is functioned as the voltage source, where the extra generator 5 is turned to be operated under the P/Q mode to provide power. If mains 8 is back to be operated normally, the energy storage system 2 will connect the grid back to mains 8.

Scenario 2: Energy storage system failed and extra generator in standby

When the energy storage system 2 fails and mains 8 is operated abnormally, the grid is turned from mains-connected to islanding. Therein, the extra generator 5 is functioned (in a V/F mode) as the voltage source of the grid under the islanding mode; and the synchronizing switch 7 is open. When mains 8 is back to be operated normally but the energy storage system 2 is not repaired, the extra generator 5 is connected back to mains 8 and the grid itself is turned to be operated under the P/Q mode.

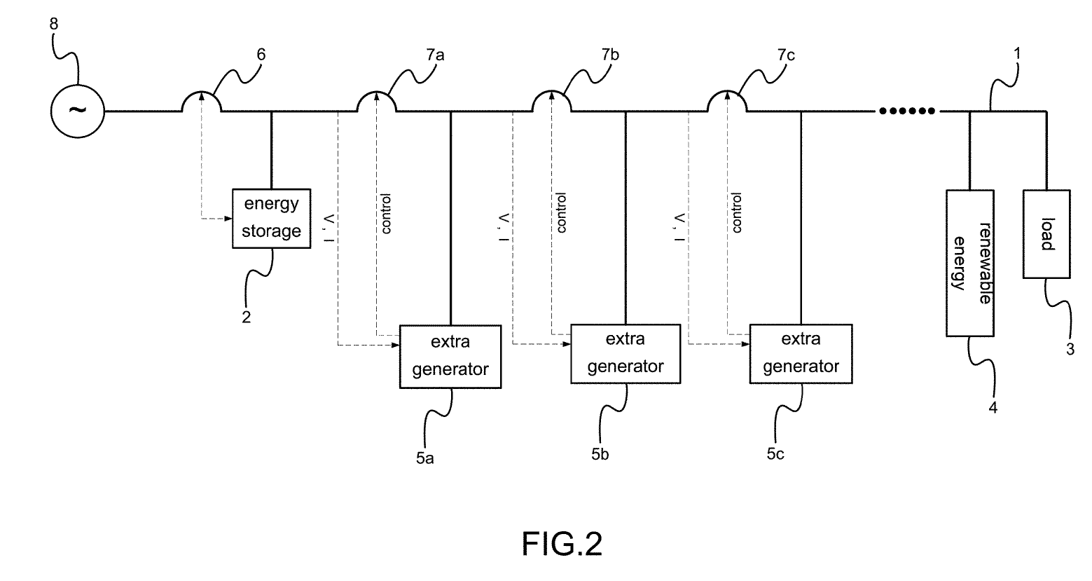

Please further refer to FIG. 2, which is a view showing a second state-of-use. As shown in the figure, the second state-of-use is different from the first state-of-use only in that there are a plurality of extra generators 5a,5b,5c and a plurality of synchronizing switches 7a,7b,7c. Therein, the synchronizing switches 7a,7b,7c are connected in series and are separately connected to separated ones of the extra generators 5a,5b,5c. The second state-of-use has the following one scenario.

Scenario 3: Energy storage system failed with a plurality of extra generators

In the second state-of-use, the extra generators 5a,5b,5c are connected with the synchronizing switches 7a,7b,7c, separately. When the energy storage system 2 fails and mains 8 is operated abnormally, the first extra generator 5a will become the voltage source and the first synchronizing switch 7a will be open to be disconnected with mains 8. As follows, if the first extra generator 5a fails, the second extra generator 5b will become the voltage source and the second synchronizing switch 7a will be open. And so forth. Thus, the risk caused by providing one voltage source only can be reduced and the stability of UPS for the grid increased.

Thus, the uses of the present invention are described above with the following features achieved:

1. Increasing stability of UPS for grid
a. The risk of providing one energy storage system only as a voltage source is avoided.
   2. Increasing choices for connection
a. If an energy storage system exists, the energy storage system is used to connect back to mains with priority.
b. If the energy storage system does not exist, an extra generator is used with a mains-connected synchronizing switch and a synchronization controller of the extra generator to connect back to mains.
   3. Avoiding dependence on energy storage system
a. When mains is operated abnormally and the energy storage system even fails, the synchronizing switch can be still off to make the extra generator functioned as the voltage source of the grid.
b. When the renewable energy and the energy storage system do not have sufficient energy to bear the load under an islanding mode, the extra generator can provide sufficient energy.
   4. Saving cost (by extra generator but no extra energy storage system)
a. No extra energy storage system needs to be bought as a minor voltage source. In terms of price, an extra generator is cheaper than an energy storage system.
b. Extra generator has lower failure rate than energy storage system. In terms of maintenance cost, it is also even lower than that of the battery module of energy storage system.
c. Static switch has higher price than synchronizing switch. All it takes is to install the synchronizing switch at the most critical position where quick-switching is needed.

To sum up, the present invention is an apparatus of controlling UPS for grid, where an extra generator is functioned as a voltage source for enhancing stability and security of a grid when the grid turns from mains-connected to islanding or when the grid is operated under the islanding mode owing to the failure of an energy storage system; the present invention thus avoids black-out of the grid owing to the failure of the energy storage system; and, according to requirements, mastership can be exchanged between the energy storage system and the extra generator for enhancing stability and reliability of power supply.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

1. An apparatus for controlling uninterruptible power supply (UPS) for a power grid, comprising:
a power bus;
a load connected directly to said power bus;
a renewable energy connected directly to said power bus;
at least one extra generator connected directly to said power bus;
an energy storage system;
at least one synchronizing switch connected to said extra generator and connecting said energy storage system to said power bus;
a mains; and
a static transfer switch connecting said mains to said energy storage system and to said at least one synchronizing switch.

2. The apparatus according to claim 1, wherein said synchronizing switch comprises a primary and a secondary connected to said at least one extra generator.

3. (canceled)

4. The apparatus according to claim 1, wherein the following steps are processed when said energy storage system is operated normally but mains is operated abnormally:
(a) said grid turns from mains-connected to be operated under an islanding mode;
(b) said energy storage system is functioned as a voltage source of said grid under said islanding mode; and
(c) said at least one extra generator is operated under a P/Q mode as a power provider.

5. The apparatus according to claim 4, wherein, when said energy storage system fails under said islanding mode, said extra generator replaces said energy storage system to be functioned as said voltage source.

6. The apparatus according to claim 4, wherein, after said energy storage system is back to be operated normally under said islanding mode, said energy storage system takes control of said voltage source and said extra generator is turned to be operated under a P/Q mode as a power provider of said grid.

7. The apparatus according to claim 6, wherein, after mains is back to be operated normally, said energy storage system connects said grid back to mains.

8. The apparatus according to claim 1, wherein, when said energy storage system fails and mains is operated abnormally, said at least one extra generator is functioned as said voltage source of said grid under said islanding mode.

9. The apparatus according to claim 8, wherein, after mains is back to be operated normally but said energy storage system is not repaired, said at least one extra generator connects said grid back to mains.
